(19) United States
(12) Patent Application Publication
(10) Pub. No.: US 2009/0005899 A1
(43) Pub. Date: Jan. 1, 2009

(54) PUNCH REPRESENTATION FOR PUNCH GEOMETRY

(75) Inventors: Gerald Hochenauer, Melk (AT); Matthew James Bussey, Sherwood, OR (US); Seth A. Hindman, Tigard, OR (US)

Correspondence Address: FISH & RICHARDSON P.C., PO BOX 1022, MINNEAPOLIS, MN, 55440-1022, US

(73) Assignee: AUTODESK, INC., San Rafael, CA (US)

(21) Appl. No.: 11/771,852

(22) Filed: Jun. 29, 2007

(51) Int. Cl. G06F 19/00

(52) U.S. Cl. 700/183

(57) ABSTRACT

The present disclosure includes, among other things, systems, methods and program products for representing punch geometry and associated manufacturing information.

### BACKGROUND

Sheet metal part production is often automated. Flat stock is cut to shape and internal cutouts, reliefs, and deformations such as dimples, lances, holes, knockouts and louvers are created by Computer Numerically Controlled (CNC) turret punch machines prior to forming the folded part. Each punch “hit” is programmed with a tool number and tool center location on flat stock. Some machines can also rotate either the tool, or the stock, to add an angle variable to the mix. A number of punch operations can be performed at once, typically cutting the material and/or deforming it in a single step or series of discrete steps. For manufacturing purposes, most, if not all punch operations are done while the part is in a flat state (known as the flat pattern). Typically once punch operations are performed, bending and other deformation processes are used to create the final sheet metal part or punch geometry.

Computer aided design (CAD) or drawing programs allow users to create three-dimensional (3D) models of the punch geometry for sheet metal part production. However, users typically need to visualize the corresponding two-dimensional (2D) flat pattern representation of the punch geometry on flat stock. Some CAD programs accomplish this by replacing visual representations of punch geometry with empty spaces on a visual representation of flat stock but this fails to convey much information about the punch geometry. Alternatively, users are required to manually draw flat patterns that correspond to punch geometry. This can be time consuming and error prone, however.

### SUMMARY

In general, one aspect of the subject matter described in this specification can be embodied in a method that includes associating a two-dimensional punch representation with a three-dimensional punch geometry, the punch geometry being a graphical representation of one or more modifications to a sheet of material. Input to view the associated punch representation is accepted. The punch geometry is automatically replaced with the punch representation in a graphical representation of the sheet. Other implementations of this aspect include corresponding systems, apparatus, and computer program products.

These and other implementations can optionally include one or more of the following features. The modifications reflect one or more cuts or punches to the sheet. The manufacturing information is associated with the punch representation where the manufacturing information can be used to manufacture the associated punch geometry from the sheet. The manufacturing information includes one or more of: center location, tool identification, punch direction, punch depth, or angular orientation. Manufacturing information associated with the punch representation can be extracted. The punch geometry is automatically projected to create the punch representation. A two-dimensional drawing can be accepted as the punch representation. The punch representation is parametrically associated with the punch geometry so that a change to the punch geometry's shape automatically causes a change to the punch representation's shape.

Particular implementations of the subject matter described in this specification can be implemented to realize one or more of the following advantages. Flat patterns are displayed automatically for punch geometry, and vice versa. Manufacturing information can be associated with flat patterns and only needs to be entered once. All manufacturing information is recoverable from the flat pattern representation. Flat patterns can be automatically created by projecting punch geometry onto a 2D surface or can be manually defined. Flat pattern representations of punch geometry can be parametrically associated with the punch geometry so that the flat pattern (and associated manufacturing information) will automatically change to reflect changes in the punch geometry. Flat pattern representations are part of the same CAD model that includes the corresponding punch geometry.

The details of one or more implementations of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 is a graphical representation of punch geometry.

FIG. 2 is a two-dimensional punch representation.

FIG. 3A is a punch representation that includes two-dimensional symbols.

FIG. 3B is a three-dimensional punch geometry.

FIG. 4 is a punch representation with associated manufacturing information.

FIG. 5A shows a three-dimensional punch geometry that includes features made by a family of punch tools.

FIG. 6 is a flowchart of a method for replacing a three-dimensional punch geometry with a two-dimensional punch representation.

FIG. 7 is a schematic diagram of a generic computer system.

Like reference numbers and designations in the various drawings indicate like elements.

### DETAILED DESCRIPTION

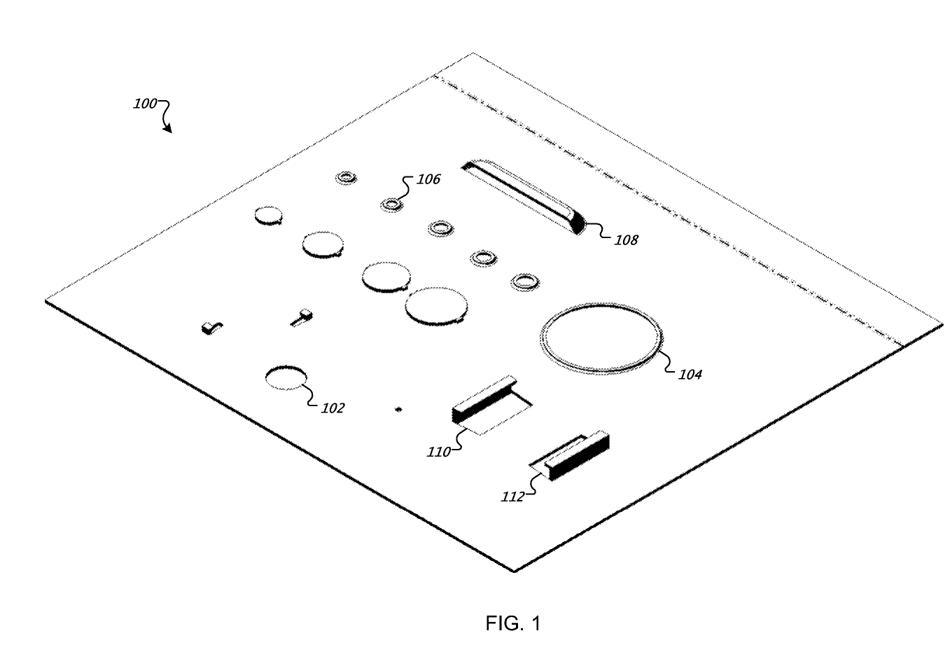

FIG. 1 is a three-dimensional graphical representation of punch geometry 100 as presented by a CAD or drawing program, for example. The punch geometry 100 visually represents a piece of sheet metal or other material from which parts can be manufactured. The sheet of material can be cut to a shape, modified, and then folded up by automated part production. Features such as louvers, holes, dimples, embosses and knockouts can be created by making modifications to the sheet of material during the manufacturing process. For example, the punch geometry 100 includes a hole 102, as well as other features 104, 106, 108, 110 and 112, which include raised edges. Modifications, such as features 102, 104, 106, 108, 110 and 112, can be made by cutting and punching operations performed by a punch tool. Modifications to the sheet of material can be performed while the sheet is in a flat state.

A graphical representation of modifications to a sheet of material can be referred to as a three-dimensional punch geometry. A three-dimensional punch geometry is a visual representation of what a sheet of material will look like after punch operations have been performed. After punch operations are completed, deformation processes, such as bending, can be performed to create a final part.

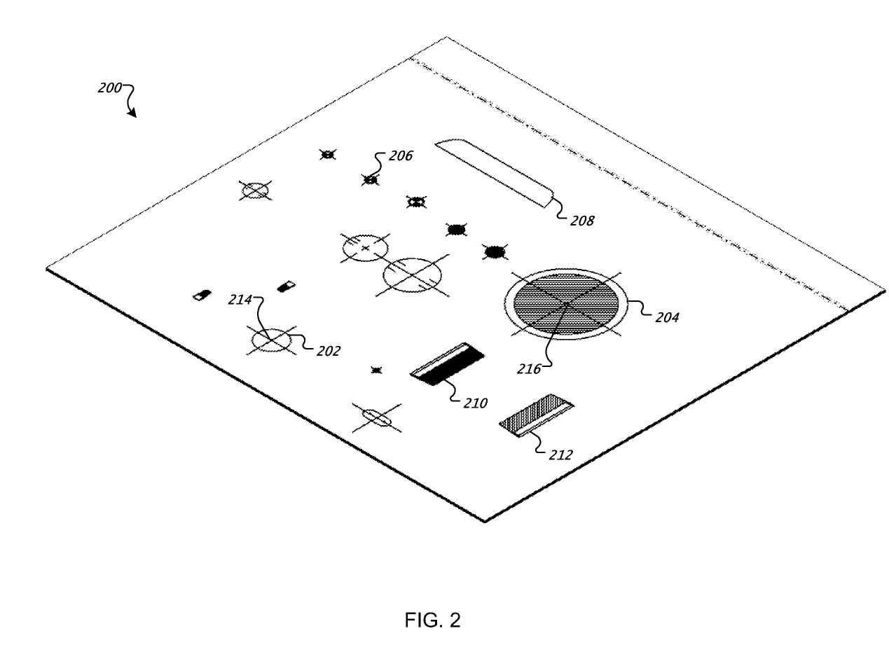

FIG. 2 is a two-dimensional punch representation 200, as presented by a CAD or drawing program, for example. A three-dimensional punch geometry can illustrate how pieces of material stick out from a sheet as a result of punch operations, but a three-dimensional punch geometry might not illustrate the exact location where a tool should punch into the material to create the feature. A two-dimensional graphical representation of one or more punches, referred to as a punch representation, can be associated with a three-dimensional punch geometry. A punch representation can indicate where punch tools should strike the sheet.

A punch representation can be generated from a three-dimensional punch geometry.

For example, a user can, while viewing a three-dimensional punch geometry, provide an input requesting to view the punch geometry as a punch representation. A punch representation can be an alternative representation of a 3D part geometry as a flat, 2D pattern. A punch representation can be stored in a file or database and can be communicated between applications.

A punch representation can include symbols on the surface of the sheet which represent punch operations. Symbols can give visual cues which show the result of a punch process. For example, the punch representation 200 includes a symbol 202 which is a two-dimensional representation of the three-dimensional punch feature 102. Other symbols on the punch representation 200 correspond to other features on the sheet of material 100. For example, symbols 204, 206, 208, 210 and 212 correspond to punched features 104, 106, 108, 110 and 112, respectively.

A symbol can include a center mark representing where the center of a punch tool should strike the sheet. For example, symbol 202 includes a center mark 214. As another example, symbol 204 includes a center mark 216.

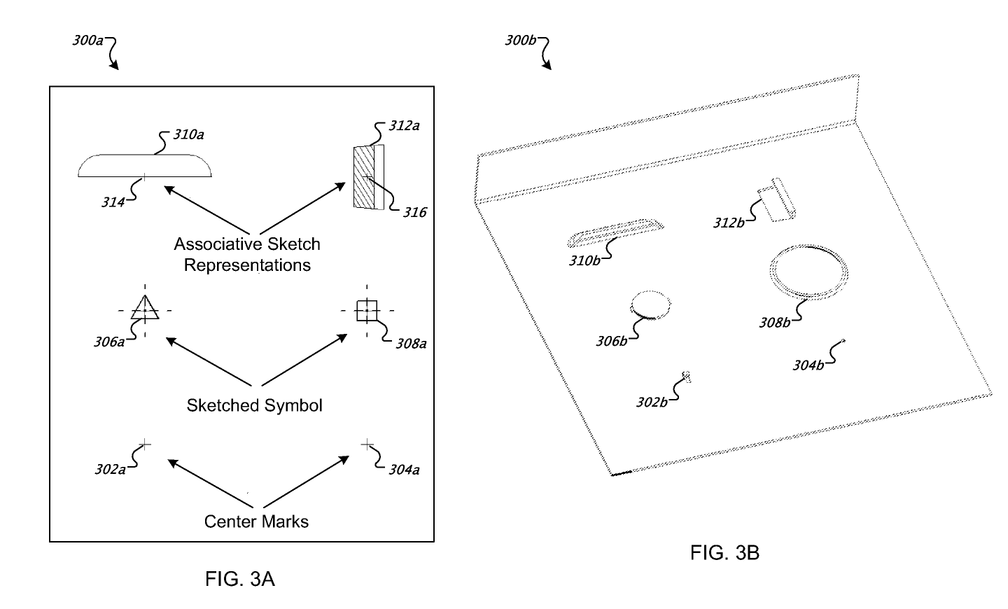

FIG. 3A is a punch representation 300a that includes two-dimensional symbols. Symbols on the punch representation 300a represent features which are shown in FIG. 3B on a three-dimensional punch geometry 300b. For each three-dimensional feature shown in FIG. 3B, there is a corresponding two-dimensional symbol representation shown in FIG. 3A. For example, the symbol 302a is a two-dimensional symbol representing the three-dimensional feature 302b.

In various implementations, three types of symbols can be used on a punch representation. A first type of symbol is a center mark. A center-mark symbol is a designation of a punch center location. For example, the symbol 302a is a center mark shown as a “cross-hairs” symbol. The center mark 302a illustrates the location where a punch tool should strike the sheet in order to create the feature 302b. A second center mark 304a is a two-dimensional representation of a feature 304b.

A second type of symbol that can appear on a punch representation is a sketched symbol. A sketched symbol is a two-dimensional abstract representation of a three-dimensional feature, and can have more detail than a center mark, although a sketched symbol can include a center mark. A sketched symbol can be created by a user.

A sketched symbol 306a is a two-dimensional representation of a three-dimensional feature 306b. The sketched symbol 306a provides an illustration of the punch tool center mark location required to create the feature 306b, as well as providing an illustration of the size of the feature 306b. A second sketched symbol 308a represents a three-dimensional feature 308b.

A third type of symbol that can appear on a punch representation is an associative sketch representation. With an associative sketch representation, the orientation, size and shape of the two-dimensional symbol can update associatively as the corresponding feature in the three-dimensional punch geometry changes. A change in shape, size, position or orientation of the three-dimensional punch feature can automatically cause a corresponding change to occur to the corresponding symbol in the punch representation. For example, an associative sketch representation 310a is a representation of a three-dimensional feature 310b. If the feature 310b is moved or sized, the associative sketch representation 310a can automatically change in a corresponding manner.

A second associative sketch representation 312a is a representation of a three-dimensional feature 312b. If the three-dimensional feature 312b is changed, the associative sketch representation 312a can be changed accordingly. In contrast, sketched symbols do not associatively update. If the three-dimensional feature 306b changes size or shape, the corresponding sketched symbol 306a will not change size or shape. However, if the three-dimensional feature 306b should move, the corresponding sketched symbol 306a will move associatively.

Associative sketch representations can include a center mark, such as center marks 314 and 316. Associative sketch representations can be created by the user by projecting the edges of the three-dimensional feature onto a two-dimensional plane. Associative sketch representations, as well as center marks and sketched symbols, can be created before or after the three-dimensional punch geometry is created.

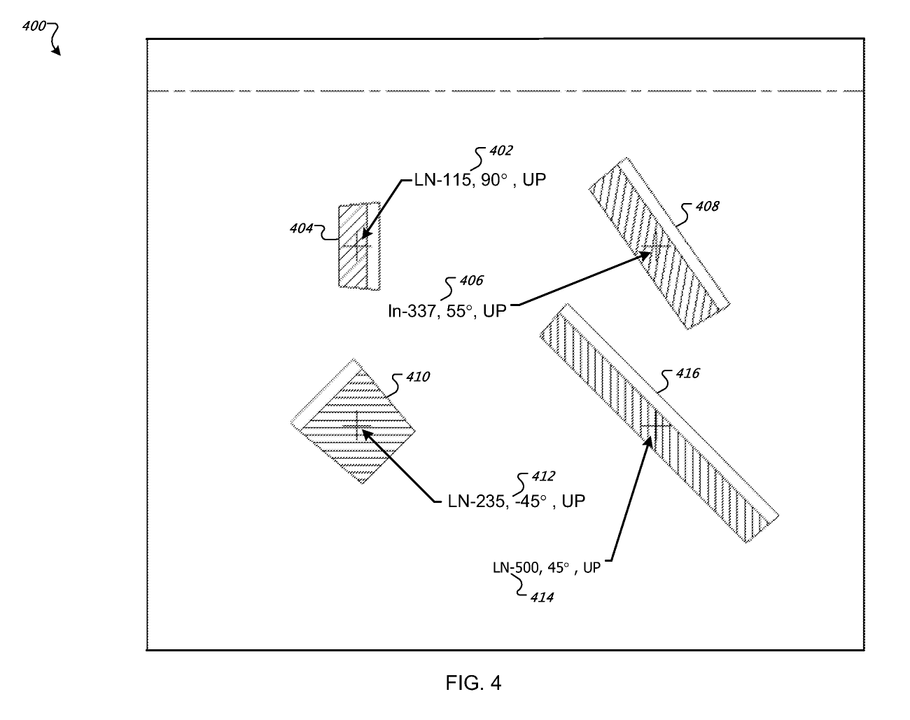

FIG. 4 is a punch representation 400 with associated manufacturing information. A punch representation can include manufacturing information which can be used to document manufacturing processes. Manufacturing information can be used to manufacture three-dimensional features associated with punch representation symbols. Manufacturing information can be displayed on a punch representation as a set of annotations, as shown in FIG. 4. Manufacturing information can be entered by the user when a three-dimensional punch geometry is created, and can be stored in a file or a database.

Manufacturing information can include information related to a punch tool that can be used to create a feature, such as an identification of the punch tool to be used, a punch center location, an angular rotation, and a punch direction. For example, a first set of manufacturing information 402 associated with an associative sketch representation 404 includes a tool identification of “LN-115”, an angular rotation of 90 degrees, and a punch direction of “UP” (i.e., the punch tool should strike from the bottom to the top of the sheet).

A second set of manufacturing information 406 associated with an associative sketch representation 408 includes a tool identification of “LN-337”, an angular rotation of 55 degrees, and a punch direction of “UP”. A third set of manufacturing information 410 associated with an associative sketch representation 412 includes a tool identification of “LN-235”, an angular rotation of −45 degrees, and a punch direction of “UP”. A fourth set of manufacturing information 414 associated with an associative sketch representation 416 includes a tool identification of “LN-500”, an angular rotation of 45 degrees, and a punch direction of “UP”.

Manufacturing information can include other information, such as a punch depth value, which can indicate how far a tool should punch into the sheet. A punch depth value can vary based on factors such as the thickness of the material being used, the desired height of the punch, for example. Manufacturing information can be extracted from a punch representation or a three-dimensional punch geometry feature. Manufacturing information can be queried using an Application Programming interface (API). Such an API can be used by manufacturing applications. For example, a CAD system can extract manufacturing information from a punch representation symbol into a file, and a manufacturing system can import the file and use the imported information to perform applicable manufacturing steps to create the associated three-dimensional feature.

Manufacturing information can be updated automatically if a punch representation or the associated punch geometry is modified. For example, if an associative punch with a sketch symbol representation is rotated, an angular rotation value can be updated in accordingly in the manufacturing information that is associated with the symbol.

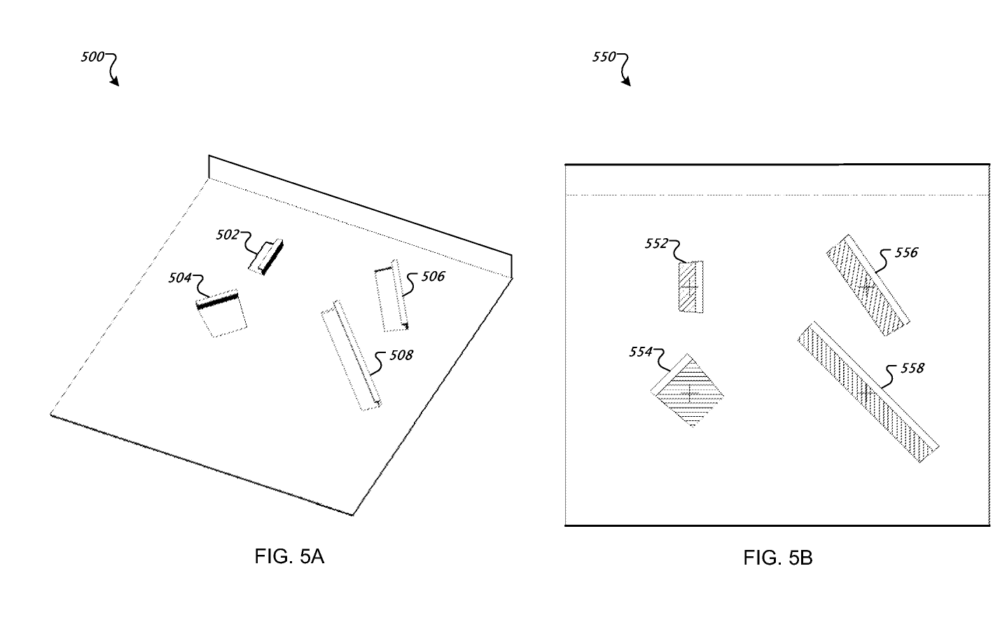

FIG. 5A shows a three-dimensional punch geometry 500 that includes features made from a family of punch tools. A punch tool can be part of a family of punch tools, where each tool in the family creates the same type of feature, but in a different size. For example, features 502, 504, 506 and 508 are three-dimensional features that can be made from different punch tools that are from the same family of punch tools.

Punch tools that are part of a family can be individually identified through a set of parameters. For example, parameters can include width and height values. Punch tool parameters can be either continuous or discrete. A continuous parameter can support values in a continuous range. For example, a height value can be allowed to be adjusted to any value within a range of values (e.g., a height value may be allowed to be any value between 1 and 5 inches, such as 3.24). A discrete parameter can support values that come from a finite set of values. For example, a punch tool may be able to create features that are 1, 2, 3, or 4 inches wide, but not 2.5 or 3.25.

Parameter values can be part of manufacturing information that is associated with a punch representation. FIG. 5B shows a punch representation 550 that is associated with the three-dimensional punch geometry 500 shown in FIG. 5A. Manufacturing information associated with the associative sketched representations 552, 554, 556, and 558 can include parameter values which can identify a punch tool to use from a family of punch tools.

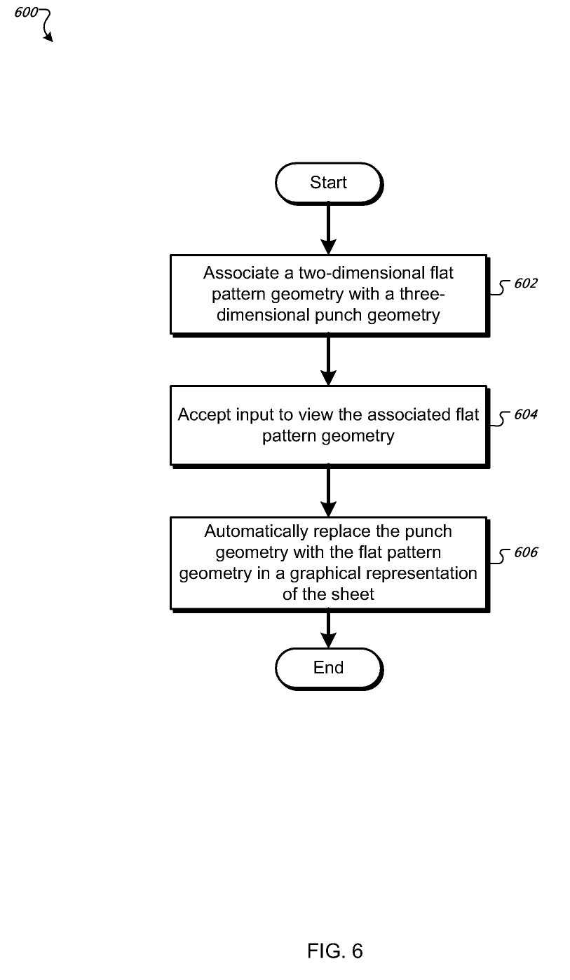

FIG. 6 is a flowchart of a method 600 for replacing a three-dimensional punch geometry with a two-dimensional punch representation. A two-dimensional punch representation is associated with a three-dimensional punch geometry (step 602). For example, a user can create a three-dimensional punch geometry such as the three-dimensional punch geometry 100 of FIG. 1. A two-dimensional punch representation, such as the punch representation 200 of FIG. 2, can be created and associated with the three-dimensional punch geometry. The punch representation can be created by projecting edges of three-dimensional features to a two-dimensional surface. As another example, the user can provide two-dimensional symbols and associate them with three-dimensional features.

Next, input is accepted to view the associated punch representation (step 604). For example, the user can be viewing a three-dimensional punch geometry such as 100 from FIG. 1. The user may desire to view the associated punch representation and can provide an input such as a menu or button selection to request that the associated punch representation be displayed.

Next, the punch geometry is automatically replaced with the punch representation in a representation of the sheet. For example, a view window that is currently displaying a graphical representation of a three-dimensional punch geometry, such as 100 of FIG. 1, can change to display a graphical representation of a two-dimensional punch representation, such as 200 of FIG. 2.

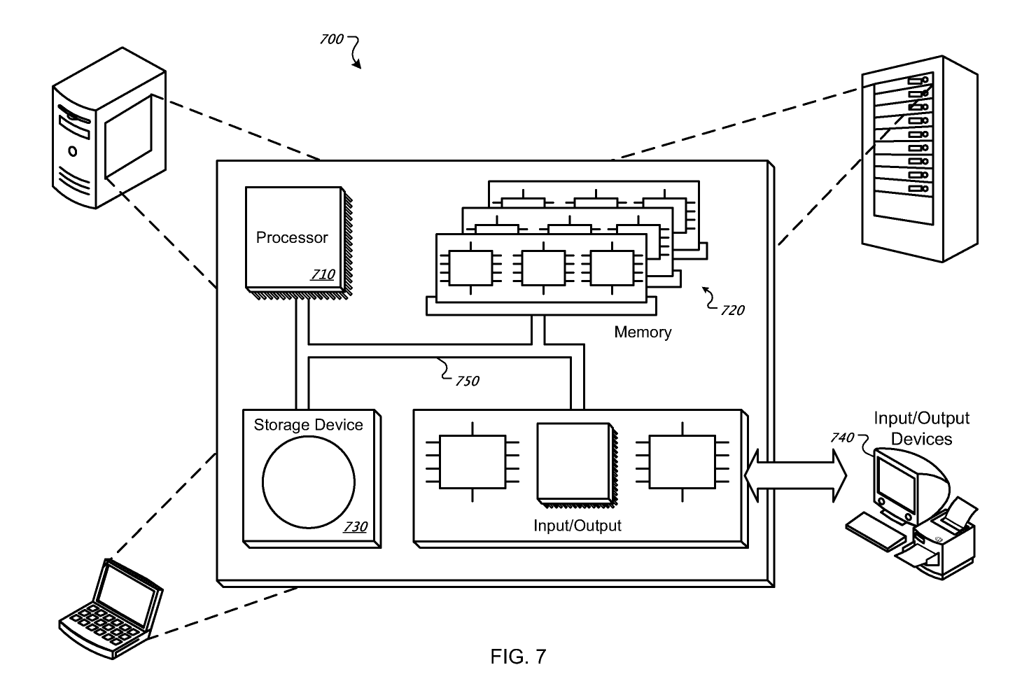

FIG. 7 is a schematic diagram of a generic computer system 700. The system 700 can be used for practicing operations described in association with the method 600. The system 700 can include a processor 710, a memory 720, a storage device 730, and input/output devices 740. Each of the components 710, 720, 730, and 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 is a computer readable medium such as volatile or non volatile that stores information within the system 700. The memory 720 could store data structures representing three-dimensional punch geometries, punch representations and manufacturing information, for example. The storage device 730 is capable of providing persistent storage for the system 700. The storage device 730 may be a floppy disk device, a hard disk device, an optical disk device, or a tape device, or other suitable persistent storage means. The input/output device 740 provides input/output operations for the system 700. In one implementation, the input/output device 740 includes a keyboard and/or pointing device. In another implementation, the input/output device 740 includes a display unit for displaying graphical user interfaces.

The input/output device 740 can provide input/output operations for a CAD system. The CAD system can be, for example, Autodesk Inventor, available from Autodesk, Inc., of San Rafael, Calif., or another CAD application or other software application. The CAD system can include computer software components that manage three-dimensional punch geometries and punch representations. Such software components can be persisted in storage device 730, memory 720 or can be obtained over a network connection, to name a few examples. A CAD system can be used to export information to a punch machine or manufacturing system. For example, a file can be created which contains information related to three-dimensional punch geometries and two-dimensional punch representations. The file can be imported and read by a manufacturing system.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the invention have been described. Other implementations are within the scope of the following claims. For example, the actions recited in the claims can be performed in a different order and still achieve desirable results.

What is claimed is:

1. A computer program product, encoded on a computer-readable medium, operable to cause data processing apparatus to perform operations comprising:
associating a two-dimensional punch representation with a three-dimensional punch geometry, the punch geometry being a graphical representation of one or more modifications to a sheet of material;
accepting input to view the associated punch representation; and
automatically replacing the punch geometry with the punch representation in a graphical representation of the sheet.

2. The program product of claim 1 where the modifications reflect one or more cuts or punches to the sheet.

3. The program product of claim 1, further comprising:
associating manufacturing information with the punch representation where the manufacturing information can be used to manufacture the associated punch geometry from the sheet.

4. The program product of claim 3 where the manufacturing information includes one or more of: center location, tool identification, punch direction, punch depth, or angular orientation.

5. The program product of claim 3, further comprising:
extracting manufacturing information associated with the punch representation.

6. The program product of claim 1, further comprising:
projecting the punch geometry to automatically create the punch representation.

7. The program product of claim 1, further comprising:
accepting a two-dimensional drawing as the punch representation.

8. The program product of claim 1, further comprising:
parametrically associating the punch representation with the punch geometry so that a change to the punch geometry's shape automatically causes a change to the punch representation's shape.

9. A computer-implemented method, comprising:
associating a two-dimensional punch representation with a three-dimensional punch geometry, the punch geometry being a graphical representation of one or more modifications to a sheet of material;
accepting input to view the associated punch representation; and
automatically replacing the punch geometry with the punch representation in a graphical representation of the sheet.

10. The method of claim 9 where the modifications reflect one or more cuts or punches to the sheet.

11. The method of claim 9, further comprising:
associating manufacturing information with the punch representation where the manufacturing information can be used to manufacture the associated punch geometry from the sheet.

12. The program product of claim 11 where the manufacturing information includes one or more of: center location, tool identification, punch direction, punch depth, or angular orientation.

13. The program product of claim 11, further comprising:
extracting manufacturing information associated with the punch representation.

14. The method of claim 9, further comprising:
projecting the punch geometry to automatically create the punch representation.

15. The method of claim 9, further comprising:
accepting a two-dimensional drawing as the punch representation.

16. The method of claim 9, further comprising:
parametrically associating the punch representation with the punch geometry so that a change to the punch geometry's shape automatically causes a change to the punch representation's shape.

17. A system comprising a display device and processor electronics configured to perform operations comprising:
associating a two-dimensional punch representation with a three-dimensional punch geometry, the punch geometry being a graphical representation of one or more modifications to a sheet of material;
accepting input to view the associated punch representation; and
automatically replacing the punch geometry with the punch representation in a graphical representation of the sheet.

18. The system of claim 17 where the modifications reflect one or more cuts or punches to the sheet.

19. The system of claim 17 where the processor electronics are configured to perform operations comprising:
associating manufacturing information with the punch representation where the manufacturing information can be used to manufacture the associated punch geometry from the sheet.

20. The system of claim 19 where the manufacturing information includes one or more of: center location, tool identification, punch direction, punch depth, or angular orientation.

21. The system of claim 17 where the processor electronics are configured to perform operations comprising:
parametrically associating the punch representation with the punch geometry so that a change to the punch geometry's shape automatically causes a change to the punch representation's shape.
